(19) United States
(12) Patent Application Publication
(10) Pub. No.: US 2017/0293856 A1
(43) Pub. Date: Oct. 12, 2017

(54) CLUSTERING HIGH DIMENSIONAL DATA USING GAUSSIAN MIXTURE COPULA MODEL WITH LASSO BASED REGULARIZATION

(71) Applicant: Xerox Corporation, Norwalk, CT (US)

(72) Inventors: Sakyajit Bhattacharya, Bangalore (IN); Vaibhav Rajan, Bangalore (IN); Asim Anand, Bangalore (IN)

(73) Assignee: Xerox Corporation

(21) Appl. No.: 15/093,302

(22) Filed: Apr. 7, 2016

(51) Int. Cl. G06N 99/00; G06F 17/30

(52) U.S. Cl. CPC G06N 99/005; G06F 17/30598

(57) ABSTRACT

LASSO constraints can lead to a Gaussian mixture copula model that is more robust, better conditioned, and more reflective of the actual clusters in the training data. These qualities of the GMCM have been shown with data obtained from: digital images of fine needle aspirates of breast tissue for detecting cancer; email for detecting spam; two dimensional terrain data for detecting hills and valleys; and video sequences of hand movements to detect gestures. Using training data, a GMCM estimate can be produced and iteratively refined to maximize a penalized log likelihood estimate until sequential iterations are within a threshold value of one another. The GMCM estimate can then be used to classify further samples. The LASSO constraints help keep the analysis tractibe such that useful results can be found and used while the result is still useful.

### TECHNICAL FIELD

Embodiments are generally related to automated or unattended “big data” analysis and automated or unattended sample classification in big data environments.

### BACKGROUND OF THE INVENTION

“Big data” refers to the massive amounts of data being collected and warehoused in volumes too large for human analysis or even for automated analysis by previous generation computers and computational techniques. Current data center clusters can house many petabytes of data while even more petabytes of data flow through those data centers. The sources of those petabytes of data include: sensors in the internet-of-things; humans sending email, messages, photographs, and videos; computers processing transactions; and machines coordinating their operations. The data, once analyzed, can provide important insight into human and animal health, agriculture, manufacturing, security, scene content, gesture interpretation, and content filtering. It is also crucial that the analysis be performed in a timely manner such that useful results are obtained before the time to act has passed. Systems and methods for automated or unattended analysis of massive data sets or for using the analytical results to process masses of data are needed.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings and abstract as a whole.

It is therefore an aspect of the embodiments to provide improved detection and descriptions of clusters within data. The clusters within the data can be estimated, described, and modeled by a Gaussian Mixture Copula Model (GMCM). A GMCM can describe a set of parameters that can be used in association with a GMCM.

It is another aspect of he embodiments that training data is obtained from at least one server. The server is a computer having a processor, memory, non-transient memory, and a transceiver for communicating with other computers. The clustered data includes many training samples with each sample coming from a known cluster. Each of the training samples is multivariate and can be described by a one dimensional array or vector.

It is yet another aspect of the embodiments for at least one processor to estimate a GMCM which is described by a parameter set. The parameter set contains mean vectors, covariance matrices, weights, and marginal distributions. The GMCM estimate can be refined by refining the parameter set describing the GMCM. The parameter set can be refined iteratively by maximizing a penalized log likelihood estimate until sequential iterations fail to change the penalized log likelihood estimate by more than a threshold value to thereby produce an estimated GMCM.

It is still yet another aspect of the embodiments that an input port can be provided to a remote computer such that the remote computer can provide a sample to be classified using the GMCM model. The input port can be, for example, an internet socket, a surface API (application program interface), or some other point of access through which one computer can submit data, a request, or a query to another computer. The sample can be plugged into the GMCM model to thereby obtain a value indicating which cluster or category (e.g., spam/not-spam) the sample most likely belongs in. The remote computer can then be provided with a response that indicates the most likely category.

It is a further aspect of the embodiments that the clustered data can be standardized before estimating the GMCM by subtracting a mean value of the training samples from the training samples and then dividing each training sample by a sample standard deviation. The parameter set can be initialized, perhaps after the clustered data, by setting each weight to a value that is greater than 0 while also ensuring that the weights sum to one and the covariance matrices are positive definite.

It is a yet further aspect of the embodiments that the marginal distributions are set to equal scaled empirical marginal distributions while estimating the GMCM.

It is still yet a further aspect of the embodiments that the clustered data can be obtained from digital images of a plurality of fine needle aspirates of breast tissue where the categories include malignant and benign, from video sequences of hand movement where the categories are of hand movement types or gestures, from email where the categories include spam and not spam, and from geographical terrain data where the categories include hill and valley.

It is a yet further aspect of the embodiments that a remote computer estimates the GMCM, provides the parameters or otherwise communicates the GMCM estimate to a local computer, and that the local computer uses the GMCM estimate to analyze samples.

It is still yet a further aspect of the embodiments that a non-transitory computer readable medium stores computer program code for estimating the GMCM and/or for using the GMCM estimate to classify a sample into a category. The computer code can also contain instructions for obtaining the cluster data over the internet, accepting or obtaining the sample over the Internet, providing data indicating the most likely category to a different computer, or for displaying data indicating the most likely category on a graphical user interface (GUI) on the display of a computer.

### BRIEF DESCRIPTION OF THE DRAWING

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a high-level flow diagram depicting a method for estimating a GMCM in accordance with an example of the embodiments;

FIG. 2 illustrates a high-level block diagram of a system estimating a GMC and categorizing samples in accordance with an example embodiment;

FIG. 3 illustrates a system with networked computers estimating a GMCM and categorizing samples in accordance with an example embodiment;

FIG. 4 illustrates a computer using computer code stored on a non-transitory computer readable medium to estimate a GMCM and categorize samples in accordance with an example of the embodiments;

FIG. 5 illustrates a schematic view of a computer system, in accordance with an embodiment; and

FIG. 6 illustrates a schematic view of a software system including a module, an operating system, and a user interface, in accordance with an embodiment.

### DETAILED DESCRIPTION

The particular values and configurations discussed in these non-limiting examples can be varied and are cited merely to illustrate at least one embodiment and are not intended to limit the scope thereof.

For a general understanding of the present disclosure, reference is made to the drawings. In the drawings, like reference numerals have been used throughout to designate identical elements. In describing the present disclosure, the following term(s) have been used in the description.

LASSO constraints can lead to a Gaussian mixture copula model that is more robust, better conditioned, and more reflective of the actual clusters in the training data. These qualities of the GMCM have been shown with data obtained from: digital images of fine needle aspirates of breast tissue for detecting cancer; email for detecting spam; two dimensional terrain data for detecting hills and valleys; and video sequences of hand movements to detect gestures. Using training data, a GMCM estimate can be produced and iteratively refined to maximize a penalized log likelihood estimate until sequential iterations are within a threshold value of one another. The GMCM estimate can then he used to classify further samples. The LASSO constraints help keep the analysis tractibe such that useful results can be found and used while the result is still useful.

The term “data” refers herein to physical signals that indicate or include information. An “image”, as in a pattern of physical light or a collection of data representing the physical light, may include characters, words, and text as well as other features such as graphics. A ‘digital image” is by extension an image represented by a collection of digital data. An image may be divided into “segments,” each of which is itself an image. A segment of an image may be of any size up to and including the whole image. The term “image object” or “object” as used herein is considered to be in the art generally equivalent to the term “segment' and will be employed herein interchangeably.

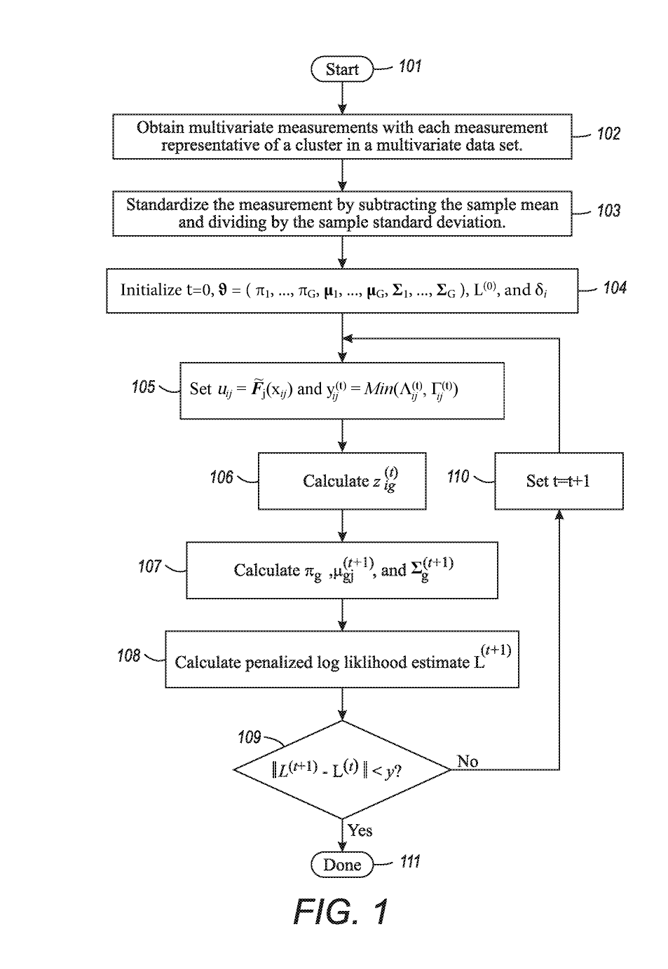

FIG. 1 illustrates a high-level flow diagram depicting a method for estimating a GMCM in accordance with an example of the embodiments. After the start 101, the process can obtain cluster data. The cluster data can be n samples (x₁, x₂, . . . , xₙ) of a p-dimensional measurement of a sample, item, message, or event. Note that in keeping with the notation used in this document, x is in lower case bold to indicate that it is a vector or one dimensional array. The cluster data can be obtained from storage on a server, from a data warehouse having many servers, or from a distributed data store. Mathematically, each of the samples can be considered to be a realization of a p-dimensional random variable x with a density following a G -component finite Gaussian Mixture Model (GMM):

$${\prod }_{i = 1}^{n} {\sum }_{g = 1}^{G} {π}_{g} φ ( {x}_{i} \vert {μ}_{g} , {Σ}_{g} )$$

where π_{g} is a mixing proportion or weight with π_{g}>0, Σ_{g=1}^{G} π_{g}=1. Furthermore, φ(xᵢ|μ_{g}, Σ_{g}) is a multivariate Gaussian density with mean μ_{g}, with covariance matrix Σ_{g}, and with parameter set [symbol] =(π₁, . . . , π_{G}, μ₁, . . . , Σ_{G}). In part, the GMM is presented here for the convenience of establishing the notation, variables, and functions that are used in the described embodiments. It is known in the art of cluster modeling that the parameters of a GMM can be found through the Expectation Maximization (AM) algorithm, through a Gibbs Sampling based approach, or other means. As such, [symbol] can be readily found from the cluster data. Latent variables inferred by the algorithm or approach can be used to identify the cluster labels of the data points.

GMMs have known limitations that can be addressed through the use of a Gaussian Mixture Copula Model. Copulas are known in the art of Gaussian modeling and are used for describing a joint distribution function as the product of marginal distribution functions that are coupled by a copula as follows (this is known as Sklar's Theorum):

F(xᵢ, x₂, . . . , xₚ)=C(F₁(x₁), F₂(x₂), . . . , Fₚ(xₚ))

where F is the joint distribution, F₁, . . . , Fₚ are the marginal distributions, and C is the copula C: [0,1]^{p}→[0,1]. Using certain values from a GMM, a Gaussian Mixture Copula can be expressed as:

$$C ( {u}_{1} , {u}_{2} , … , {u}_{p} \vert ϑ ) = \frac{{\sum }_{g = 1}^{G} {π}_{g} φ ( {y}_{i} \vert {μ}_{g} , {Σ}_{g} )}{{\prod }_{j = 1}^{p} {ψ}_{j} ( {y}_{ij} )}$$

For all the variables, i denotes the observation, i=(1, 2, . . . , n), and j denotes the dimension, j=(1, 2, . . . , p). The second subscript can be omitted when p-dimensional vectors are referenced. The first subscript can be omitted when referring to variables related to individual marginal. As mentioned above, vectors and matrices are represented in bold font. Latent variables yᵢⱼ=Ψⱼ⁻¹(uᵢⱼ) are the inverse cumulative distribution values of, the GMM along the j^{th} dimension. uᵢⱼ=Fⱼ(yᵢⱼ) and Fⱼ is to be determined marginal distribution for the j^{th} dimension. ψⱼ is the marginal density of the GMM along the j^{th} dimension. φ is the multivariate Gaussian density, and [symbol] =(π₁, . . . , π_{G}, μ₁, . . . , μ_{G}, Σ₁, . . . , Σ_{G})) is a parameter set representing mixing proportions, mean vectors, and covariance matrices as discussed above for the GMM components g=1, 2, . . . , G.

The combined density of n points with p dimensions each from a G-component Gaussian Mixture Copula can therefore be expressed as:

$${\prod }_{i = 1}^{n} \frac{{\sum }_{g = 1}^{G} {π}_{g} φ ( {y}_{i} \vert {μ}_{g} , {Σ}_{g} )}{{\prod }_{j = 1}^{p} {ψ}_{j} ( {y}_{ij} )}$$

A LASSO type penalty can be applied in finding an MLE of the unknown parameters. Specifically, a penalized log-likelihood can be maximized:

log [symbol] ( [symbol] |x)−Σ_{g=1}^{G} π_{g} Σⱼ₌₁^{p}φ(μ_{gj})

and can have a LASSO type penalty for φ(μ_{gj}) such as φ(μ_{gj})=nλₙ|μ_{gj}| where μ_{gj} is the j^{th} element in μ_{g} and λₙ is tuning parameter that depends on Other penalties can be used such as φ(μ_{gj})=[λₙ²−(\sqrt{n}μ_{gj}−λₙ)²I(\sqrt{n}μ_{gj}<λₙ)] or the SCAD penalty known in the art.

An EM algorithm for a Gaussian Mixture Copula Model can therefore estimate a value of Θ that maximizes the penalized log likelihood:

$$log {ℒ}_{pen} ( ϑ \vert {u}_{1} , {u}_{2} , … , {u}_{p} ) = {\sum }_{i = 1}^{n} log \frac{{\sum }_{g = 1}^{G} {π}_{g} φ ( {y}_{i} \vert {μ}_{g} , {Σ}_{g} )}{{\prod }_{j = 1}^{p} {ψ}_{j} ( {y}_{ij} )} - n {λ}_{n} {\sum }_{g = 1}^{G} {π}_{g} {\sum }_{j = 1}^{p} \vert {μ}_{gj} \vert$$

Certain assumptions can simplify the equation. The penalty function is non-concave and singular at the origin: it has no second derivative at 0. The parameters can be estimated by successive approximation and, if μ^{(m)} is the estimate of μ after m iterations then:

$$ϕ ( μ ) \approx n {λ}_{n} {\sum }_{g = 1}^{G} {π}_{g} {\sum }_{j = 1}^{{p}_{g}} [ \vert {μ}_{gj}^{( m )} \vert + \frac{1}{2} \frac{sign ( {μ}_{gj}^{( m )} )}{{μ}_{gj}^{( m )}} ( {μ}_{gj}^{2} - {{μ}_{gj}^{( m )}}^{2} ) \vert ]$$

where p_{g} is the number of non-zero elements in μ_{g}. Other simplifying assumptions can be made such as the marginal distributions of the mixing proportions, (π₁, . . . , mπ_{G}), being uniform on the simplex and that μ_{g}˜ [symbol] (\hat{μ}_{g}, I(\hat{μ}_{g}, I(\hat{μ}_{g})⁻¹), for g=1, 2, . . . G, where xx is the MLE derived by maximizing the penalized likelihood [symbol] ₚₑₙ and I(\hat{μ}_{g}) is the unit information matrix at \hat{μ}_{g}. With the described LASSO penalty and assumptions in place, this particular GMCM estimator can be called AECM-GMCM.

An iterative AECM-GMCM algorithm can have a number of steps as shown in FIG. 1. After the start 101, and obtaining the clustered data 102, the measurements can be standardized 103. Standardizing the measurements can include subtracting the sample mean from each sample and then dividing by the sample standard deviation. Certain other values are initialized 104 before the iterative part of the algorithm is entered. The iteration counter t can be set to zero. The GMM parameters can be initialized [symbol] =(π₁, . . . , π_{G}, μ₁, . . . , μ_{G}, Σ₁, . . . , Σ_{G}) using a random start, K-means clustering, or some other method under the constraints that π_{g}>0, Σ_{g=1}^{G} π_{g}⁽⁰⁾=1, and Σ_{g}⁽⁰⁾ is positive definite. The variable δᵢ is initialized as follows:

$${δ}_{i} = {min}_{g , j} \vert {y}_{ij}^{( 0 )} - 2 {{κ}^{( 0 )} ( {[ {Σ}_{g}^{( 0 )} + I ]}^{- 1} {Σ}_{g}^{( 0 )} 1 )}_{j} \vert$$

The iterative portion of the method is entered and values calculated 105: uᵢⱼ=\tilde{F}_{J}(xᵢⱼ) and yᵢⱼ^{(t)}=Min(Λᵢⱼ^{(t)}, Γᵢⱼ^{(t)}) where:

$${Λ}_{ij}^{( t )} = {( {\sum }_{g = 1}^{G} \frac{{π}_{g}^{( t )}}{{σ}_{g , ji}^{( t )}} )}^{- 1} [ {u}_{ij} + \frac{1}{\sqrt{2 π}} {\sum }_{g = 1}^{G} \frac{{π}_{g}^{( t )} {μ}_{gj}^{( t )}}{{σ}_{g , ji}^{( t )}} - \frac{1}{2} ] , and$$

$${Γ}_{ij}^{( t )} = {{κ}^{( t )} ( {[ {S}_{i}^{( t )} + I ]}^{- 1} {S}_{i}^{( t )} 1 )}_{j} - \frac{{δ}_{i}}{2} ( 3 - \frac{p}{{m}_{i}^{( t )} + p} ) ,$$

where κ^{(t)=max}_{g,j}(μ_{gj}^{(t)}), Sᵢ^{(t)}=Σ_{g=1}^{G} z_{ig}^{(t-1)} Σ_{g}^{(t)}, mᵢ^{(t)} is the sum of all elements of Sᵢ^{(t)}, and σ_{g,jj}^{(t)} is the j^{th} diagonal element of Σ_{g}^{(t)}.

A value of z_{ig}^{(t)} is then calculated 106 as follows:

$${z}_{ig}^{( t )} = \frac{{π}_{g}^{( t )} φ ( {y}_{i}^{( t )} \vert {μ}_{g}^{( t )} , {Σ}_{g}^{( t )} )}{{\sum }_{g = 1}^{G} {π}_{g}^{( t )} φ ( {y}_{i}^{( t )} \vert {μ}_{g}^{( t )} , {Σ}_{g}^{( t )} )}$$

Values for π_{g}^{(t+1)}, μ_{gj}^{(t+1)}, and Σ_{g}^{(t+1)} can be calculated next 107 as follows:

$${π}_{g}^{( t + 1 )} = \frac{{\sum }_{i = 1}^{n} {z}_{ig}^{( t )}}{n} , \\ {μ}_{gi}^{( t + 1 )} = {sign ( {\tilde{μ}}_{gj}^{( t )} ) [ \vert {\tilde{μ}}_{gj}^{( t )} \vert - {λ}_{n} \vert {( {\hat{Σ}}_{g}^{( t )} sign ( {\tilde{μ}}_{g}^{( t )} ) )}_{j} \vert ]}_{+} , and$$

$${Σ}_{g}^{( t + 1 )} = \frac{{\sum }_{i = 1}^{n} {{z}_{ig}^{( t + 1 )} ( {y}_{i}^{( t )} - {μ}_{g}^{( t + 1 )} )}^{T} ( {y}_{i}^{( t )} - {μ}_{g}^{( t + 1 )} )}{{\sum }_{i = 1}^{n} {z}_{ig}^{( t )}}$$

The penalized log likelihood can be calculated 108 as:

$${L}^{( t + 1 )} = {\prod }_{i = 1}^{n} {\sum }_{g = 1}^{G} {π}_{g}^{( t + 1 )} \frac{exp ( - \frac{1}{2} {( {y}_{i}^{( t )} - {μ}_{g}^{( t + 1 )} )}^{T} {Σ}_{g}^{{( t + 1 )}^{- 1}} ( {y}_{i}^{( t )} - {μ}_{g}^{( t + 1 )} ) )}{\sqrt{det ( 2 {πΣ}_{g}^{( t + 1 )} )}}$$

Finally, the improvement in the likelihood estimate can be tested against a threshold 109 as follows: ∥L^{(t+1)}−L^{(t)}∥<γ? If the difference is less than the threshold, γ, then the method is done 111. Otherwise γ is incremented 110 and the method loops back calculating values for μᵢⱼ and γᵢⱼ^{(t)}.

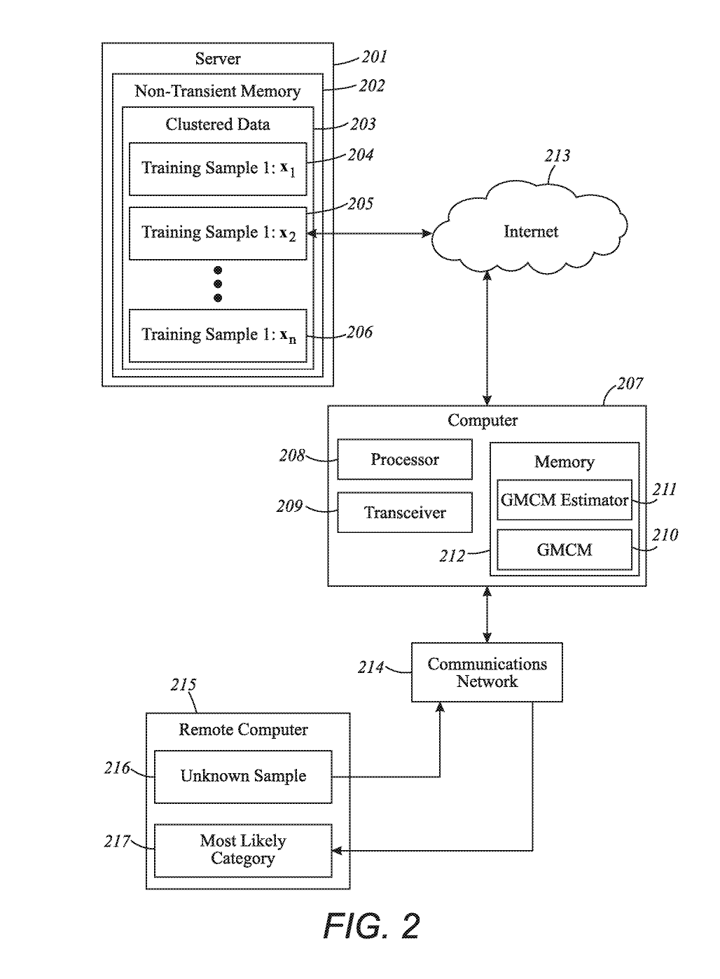

FIG. 2 illustrates a high-level block diagram of a system estimating a GM CM and categorizing samples in accordance with an example embodiment. A server 201 can store clustered data 203 in a non-transient memory 202. The clustered data includes a number of training samples 204, 205, 206. The server 201 can provide the clustered data over the internet 213 or a different communications link to a computer 207. The computer 207 has a processor 208, transceiver 209, and memory 210. The transceiver can receive and send data on behalf of the computer 207 over the Internet 213 or another communications network 214. The memory 210 can include data and program instructions for estimating a GMCM 211 and for using a GMCM 212 to classify samples. A remote computer 215 can submit an unknown sample 216 to computer 207 for classification by the GMCM 212. The computer 207 can then respond to the remote computer 215 with information indicating a most likely category 217 to which the unknown sample 216 most likely belongs.

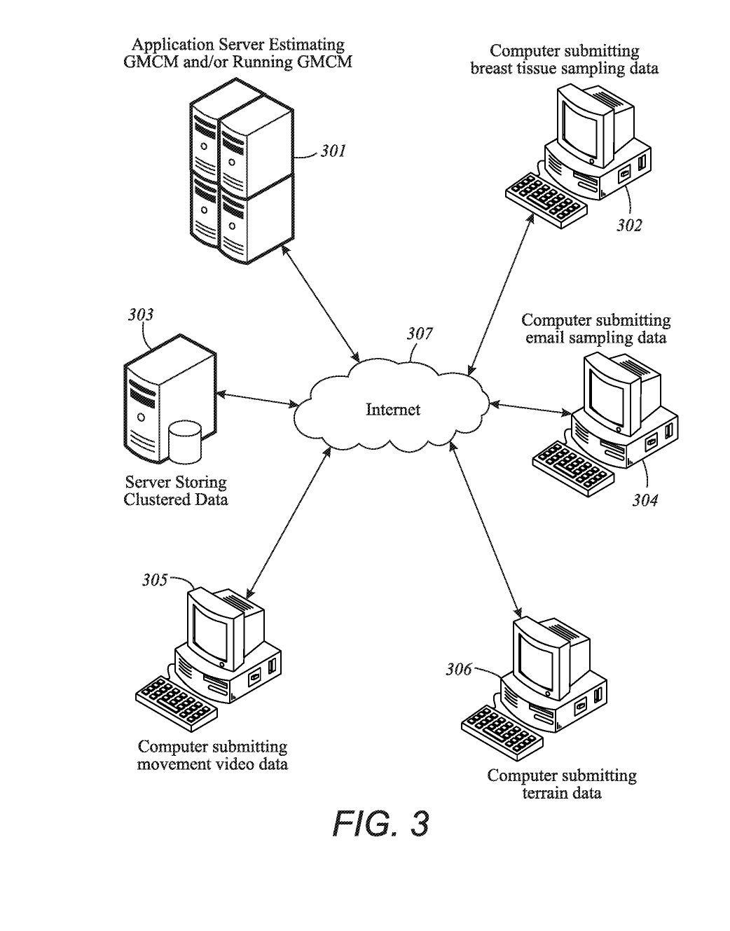

FIG. 3 illustrates a system with networked computers estimating a GMCM and categorizing samples in accordance with an example embodiment. Clustered data is stored in a server 303 connected to the Internet 307. An application server 301 can run computer code to produce or estimate a GMCM that models clustered data obtained from the server 303. Once produced, the GMCM can be run by the application server 301 to classify or categorize unknown samples. In some embodiments, the application server 303 will provide computer code to another computer such that that other computer can produce and run a GMCM based on the clustered data. The clustered data and the program code can be obtained over the internet 307 by the other computer.

The GMCM presented herein and specifically including the AECM-GMCM were tested on certain known data sets that are commonly used to test clustering and classification. The known datasets are a breast cancer dataset, a spam email dataset, a hill-valley dataset, and a libras movement dataset.

The breast cancer dataset includes features computed from a digitized image of a fine needle aspirate of a breast mass. The features describe characteristics of the cell nuclei present in the image. A separating plane was obtained using Multisurface Method-Tree (MSM-T). Relevant features were selected using an exhaustive search in the space of 1-4 features and 1-3 separating planes. There are 30 features and 569 observations in the dataset. The goal is to separate the observations in two clusters, malignant and benign,

The spam email dataset was obtained from various emails. The dataset has 4601 observations and 57 attributes, Most of the attributes indicate whether a particular word or character was frequently occurring in the e-mail. Certain run-length attributes measure the length of sequences of consecutive capital letters. The goal is to separate the dataset into two clusters, spam and not-spam.

The hill-valley dataset was obtained from different geographical characteristics of a region. Each observation represents 100 points on a two-dimensional graph. When plotted in order (from 1 through 100) as the Y co-ordinate, the points will create either a hill (a bump in the terrain) or a valley (a dip in the terrain). There are 606 observations and 100 dimensions in the dataset. The goal is to classify areas as hills or valleys.

The libras movement dataset contains 15 classes of 24 instances each, where each class references to a hand movement type, obtained through video preprocessing within 45 frames. There are 360 observations with 90 dimensions. The task is to cluster the dataset properly in the 15 classes.

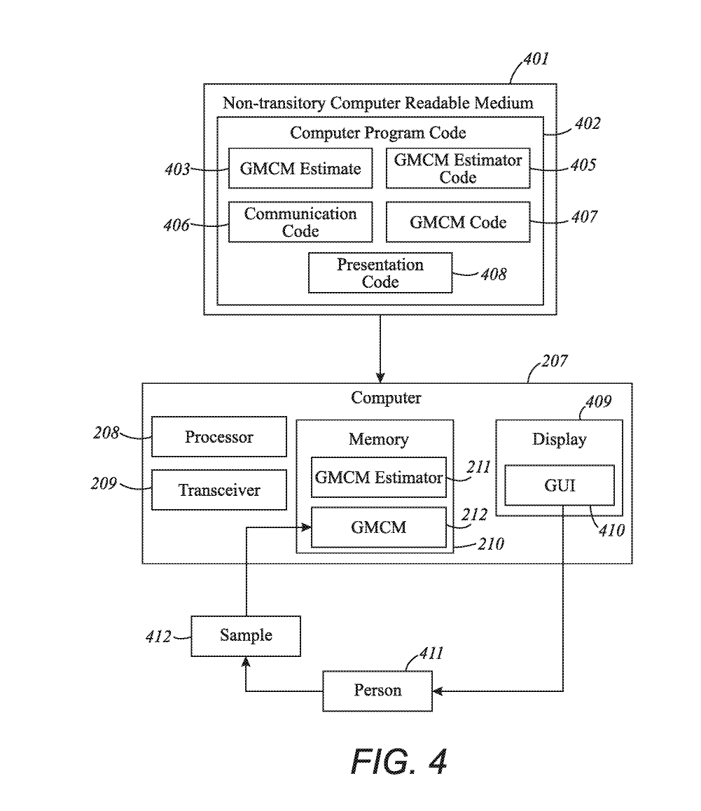

FIG. 4 illustrates a computer 207 using computer code 402 stored on a non-transitory computer readable medium 401 to estimate a GMCM 212 and categorize samples 412 in accordance with an example of the embodiments. The non-transitory computer readable medium 401 stores computer program code 402 that can be executed by a processor 208 in a computer 207. The computer program code 402 can include a GMCM estimate 403, GMCM estimator code 405, communications code 406, GMCM code 407, and presentation code 408. The GMCM estimate 403 can include a parameter set such as Θ=(π₁, . . . , π_{G}, μ₁, . . . , μ_{G}, Σ₁, . . . , Σ_{G}) or C(u₁, u₂, . . . , uₚ|Θ) which are discussed above. The GMCM estimate can alternatively be considered to be data instead of program code. The GMCM estimator code 405 can be program code that, when run, accepts cluster data and produces a GMCM estimate. The communications code 406 can be program code that, when run, controls the transfer of information into and out of a computer. The GMCM code 407 is program code that, when run, uses a GMCM estimate to classify a sample. The presentation code 408 is code that a processor 208 runs to present information to a person, perhaps within a graphical user interface (GUI) 410 on a computer display 409.

Computer 207 can obtain computer program code 402 by downloading it from a server or reading it directly from non-transitory computer readable medium 401. The processor can run the computer program code 402 to thereby run certain applications or processes. By running GMCM estimator code 405, the computer thereby runs GMCM estimator 211. By running GMCM code 407, the computer thereby runs GMCM 212. A person 411 can provide an unknown sample 412 to computer 207 such that GMCM 212 produces a result indicating the most likely class or category containing the unknown sample 412. The computer can then present the result, a representation of the result, or the category in the GUI 410 shown by display device 409.

As can be appreciated by one skilled in the art, embodiments can be implemented in the context of a method, data processing system, or computer program product. Accordingly, embodiments may take the form of an entire hardware embodiment, an entire software embodiment, or an embodiment combining software and hardware aspects all generally referred to herein as a “circuit” or “module.” Furthermore, embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, etc.

Computer program code for carrying out operations of the present invention may be written in an object oriented programming language (e.g., Java, C++, etc.). The computer program code, however, for carrying out operations of particular embodiments may also be written in conventional procedural programming languages, such as the “C” programming language or in a visually oriented programming environment, such as, for example, Visual Basic,

The program code may execute entirely on, the user's, computer, partly on the user's computer, as a stand-alone software package, partly on the user's computer and partly on a remote computer, or entirely on the remote computer. In the latter scenario, the remote computer may be connected to a user's computer through a local area network (LAN) or a wide area network (WAN), wireless data network e.g., Wimax, 802.xx, and cellular network, or the connection may be made to an external computer via most third party supported networks (for example, through the Internet utilizing an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

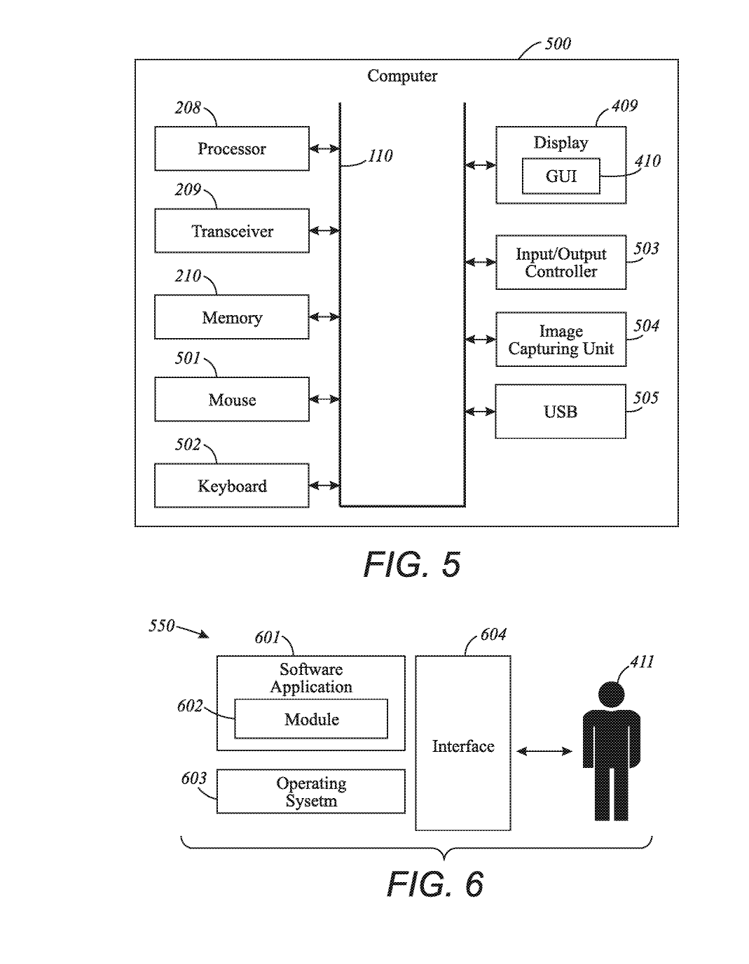

FIGS. 5-6 are shown only as exemplary diagrams of data-processing environments in which embodiments may be implemented. It should be appreciated that FIGS. 5-6 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments,

The various components of a computer can communicate electronically through a system bus or similar architecture. The system bus 506 may be, for example, a subsystem that transfers data between, for example, computer components within computer 500 or to and from other data-processing devices, components, computers, etc. Computer 500 may be implemented in some embodiments as, for example, a server in a client-server based network (e.g., the Internet) or in the context of a client and a server (i.e., where aspects are practiced on the client and the server). In yet other example embodiments, computer 500 may be, for example, a standalone desktop computer, a laptop computer, a Smartphone, a pad computing device, and so on, wherein each such device is operably connected to and/or in communication with a client-server based network or other types of networks (e.g., cellular networks, Wi-Fi, etc.). Input/output controller 503 is a generic input device that passes information between computer 500 and the outside world. Mouse 501 and keyboard 502 can accept input from a person interacting with the computer. Display 409, perhaps displaying GUI 410, can pass information from the computer 500 to a person. Image capture unit 504 is, in essence, a camera or video input to the computer. USB 505 is a standardized universal serial bus input/output port for the connection of other devices to the computer. Here, USB 505 is illustrated with the understanding that it represents any other standardized input or out port commonly deployed on computers such as firewire, VGA, HDMI, or SCSI.

FIG. 6 illustrates a computer software system 550 for directing the operation of the computer 500 depicted in FIG. 5. Software application 601 stored, for example, in memory 210 generally includes a kernel or operating system 603 and a shell or interface 604. One or more application programs, such as software application 601, may be “loaded” (i.e., transferred from, for example, mass storage or another memory location into the memory 210) for execution by the computer 500. The computer 500 can receive user commands and data through the interface 604; these inputs may then he acted upon by the computer 500 in accordance with instructions from operating system 603 and/or software application 601. The interface 604 in some embodiments can serve to display results, whereupon a user 411 may supply additional inputs or terminate a session. The software application 601 can include module(s) 602, which can, for example, implement instructions or operations such as those of the GMCM estimator discussed elsewhere herein. In some embodiments, module 602 can store other modules.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

FIGS. 5-6 are thus intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art, which are also intended to be encompassed by the following claims.

What is claimed is:

1. A method for classifying a sample into one of a plurality of categories and indicating to a remote computer a most likely category wherein the most likely category is that one of the categories to which the sample most likely belongs, the method comprising:
obtaining clustered data from at least one server, the at least one server comprising at least one server processor and a non-transient memory storing the training samples, wherein the clustered data comprises a plurality of training samples, and wherein the training samples are multivariate;
estimating, by at least one processor, a Gaussian mixture copula model (GMCM) of the clustered data wherein the GMCM is described by a parameter set, wherein the parameter set comprises a plurality of weights, a plurality of mean vectors, a plurality of covariance matrices, and a plurality of marginal distributions, and wherein the parameter set is refined by iteratively maximizing a penalized log likelihood estimate until sequential iterations fail to change the penalized log likelihood estimate by more than a threshold value to thereby produce an estimated GMCM;
providing, to a remote computer, access to an input port wherein the remote computer accesses the input port over the internet accepting the sample from the remote computer;
calculating a value by plugging the sample into the estimated GMCM wherein the value indicates the most likely category; and
providing the remote computer with a response that indicates the most likely category.

2. The method of claim 1 wherein estimating the GMCM comprises:
standardizing the clustered data by subtracting a mean value of the training samples from the training samples and then dividing each training sample by a sample standard deviation; and
initializing the parameter set after standardizing the clustered data, wherein each weight is greater than zero, wherein the weights sum to one, and wherein the covariance matrices are positive definite.

3. The method of claim 1 wherein estimating the GMCM comprises setting the marginal distributions to equal scaled empirical marginal distributions.

4. The method of claim 1 wherein the clustered data is obtained from a plurality of digital images of a plurality of fine needle aspirates of breast tissue and wherein the categories comprise malignant and benign.

5. The method of claim 1 wherein the clustered data comprise attributes obtained from email and wherein the categories comprise spam and not spam.

6. The method of claim I wherein each training sample comprises a plurality of points on a two dimensional graph representative of geographical terrain and wherein the categories comprise hill and valley.

7. The method of claim 1 wherein each training sample comprises a plurality values obtained from video sequences of hand movement and wherein the categories comprise a plurality of hand movement types.

8. A method for classifying a sample into one of a plurality of categories and indicating to a person a most likely category wherein the most likely category is that one of the categories to which the sample most likely belongs as determined by a local computer, the method comprising:
obtaining clustered data from at least one server, the at least one server comprising at least one server processor and a non-transient memory storing the training samples, wherein the clustered data comprises a plurality of training samples, and wherein the training samples are multivariate;
estimating, by at least one processor, a Gaussian mixture copula model (GMCM) of the clustered data wherein the GMCM is described by a parameter set, wherein the parameter set comprises a plurality of weights, a plurality of mean vectors, a plurality of covariance matrices, and a plurality of marginal distributions, and wherein the parameter set is refined by iteratively maximizing a penalized log likelihood estimate until sequential iterations fail to change the penalized log likelihood estimate by, more than a threshold value to thereby produce an estimated GMCM; and
providing a classification application to the local computer wherein the local computer accepts the sample and provides the sample to the classification application, wherein the classification application calculates a value by plugging the sample into the estimated GMCM, wherein the value indicates the most likely category, and wherein the local computer indicates the most likely category to a person.

9. The method of claim 8 further comprising providing the parameter set to the local computer wherein the application program inputs the parameter set to thereby instantiate the estimated GMCM.

10. The method of claim 9 wherein estimating the GMCM comprises:
standardizing the clustered data by subtracting a mean value of the training samples from the training samples and then dividing each training sample by a sample standard deviation; and
initializing the parameter set after standardizing the clustered data, wherein each weight is greater than zero, wherein the weights sum to one, and wherein the covariance matrices are positive definite.

11. The method of claim 8 wherein estimating the GMCM comprises setting the marginal distributions to equal scaled empirical marginal distributions.

12. The method of claim 10 wherein the clustered data is obtained from a plurality of digital images of a plurality of fine needle aspirates of breast tissue and wherein the categories comprise malignant and benign.

13. The method of claim 10 wherein the clustered data comprises attributes obtained from email and wherein the categories comprise spam and not spam.

14. The method of claim 10 wherein each training sample comprises a plurality of points on a two dimensional graph representative of geographical terrain and wherein the categories comprise hill and valley.

15. The method of claim 10 wherein each training sample comprises a plurality values obtained from video sequences of hand movement and wherein the categories comprise a plurality of hand movement types.

16. A computer program product for use with a computing device, the computer programming device comprising a non-transitory computer readable medium, the non-transitory computer readable medium stores a computer program code for classifying a sample into one of a plurality of categories and reporting a most likely category wherein the most likely category is that one of the categories to which the sample most likely belongs, the computer program code is executable by one or more processors to:
obtain clustered data from at least one server wherein the clustered data comprises a plurality of training samples, and wherein the training samples are multivariate;
estimate a Gaussian mixture copula model (GMCM) of the clustered data wherein the GMCM is described by a parameter set, wherein the parameter set comprises a plurality of weights, a plurality of mean vectors, a plurality of covariance matrices, and a plurality of marginal distributions, and wherein the parameter set is refined by iteratively maximizing a penalized log likelihood estimate until sequential iterations fail to change the penalized log likelihood estimate by more than a threshold value to thereby produce an estimated GMCM;
receive the sample;
calculate a value by plugging the sample into the estimated GM CM wherein the value indicates the most likely category; and
provide a response that indicates the most likely category.

17. The computer program product of claim 16 wherein the computer program code is further executable to provide the response in a graphical user interface.

18. The computer program product of claim 16 wherein the computer program code is further executable to receive the sample over the Internet and to send the response over the internee to a remote computer.

19. The computer program product of claim 1 wherein the computer program code is further executable to:
standardize the clustered data by subtracting a mean value of the training samples from the training samples and then dividing each training sample by a sample standard deviation; and
initialize the parameter set after standardizing the clustered data, wherein each weight is greater than zero, wherein the weights sum to one, and wherein the covariance matrices are positive definite.

20. The computer program product of claim 16 wherein estimating the GMCM comprises setting the marginal distributions to equal scaled empirical marginal distributions.
